(19) United States
(12) Patent Application Publication
(10) Pub. No.: US 2024/0046500 A1
(43) Pub. Date: Feb. 8, 2024

(54) METHOD AND SYSTEM FOR BODY POSE GUIDING BASED ON VIDEO CONTENTS SELECTED BY USER

(71) Applicant: MARKANY INC., Seoul (KR)

(72) Inventors: Young In KIM, Seoul (KR); Chittaranjan Sardar, West Bengal (IN); TRAN DUC TRINH, Thu Dau Mot City (VN); PHAM VAN NGHE, Ho Chi Minh (VN)

(73) Assignee: MARKANY INC., Seoul (KR)

(21) Appl. No.: 17/973,532

(22) Filed: Oct. 25, 2022

(30) Foreign Application Priority Data
Aug. 3, 2022 (KR) 10-2022-0096434
Oct. 13, 2022 (KR) 10-2022-0131639
Oct. 24, 2022 (KR) 10-2022-0137680

(51) Int. Cl. G06T 7/70; G06T 7/20; G06T 3/00; G06V 10/74; H04L 9/32

(52) U.S. Cl. CPC G06T 7/70; G06T 7/20; G06T 3/00; G06V 10/761; H04L 9/3226; G06T 2207/10016; G06T 2207/20084; G06T 2207/20044

(57) ABSTRACT

The present disclosure relates to a technology of measuring and analyzing the pose of an objective (a body) including a human body, and a system for providing a guide that can improve a concordance ratio of a copying pose to a standard pose by comparing pose information. In order to achieve the objective described above, a method of providing a user pose guide using a terminal device according to an embodiment of the present disclosure may include: inputting video selection information and obtaining a first video, in which a first action has been recorded, on the basis of the video selection information; obtaining a first action related to the first video; displaying the first video; obtaining a second video in which a second action copying the first action has been recorded; comparing the first action and the second action; and displaying pose guide information on the basis of the comparison.

### BACKGROUND OF THE DISCLOSURE

### Field of the Disclosure

The present disclosure relates to a technology of measuring and analyzing the pose of an object (a body) including a human body, and a system for providing a guide that can improve a concordance ratio of a copying pose to a standard pose by comparing pose information.

### Related Art

A so-called home training service of individuals at remote places in a non-contact manner recently has been being used. Such a home training service is to record standard exercise poses and programs from experts in advance and then give a function of inducing service users to have right exercise habits by copying corresponding poses on the basis of personal information communication devices such as a smartphone.

The most fundamental home training service method is a model broadcast showing exercise poses. Standard poses of exercise experts (e.g., a fitness trainer, a sports trainer, a Pilates teacher, a yoga teacher, etc.) are provided as video contents using a television broadcast, a VOD service, a streaming service, and an internet video sharing service, and other specified systems so that users who watch the video contents can practice exercise at remote places by copying the videos.

However, users copy actions while watching standard exercise videos, but they cannot know whether they accurately copy corresponding actions in the situation in which video contents are one-sidedly provided through broadcasting. Accordingly, many excellent exercise programs constructed by the experts are not transmitted well to users, and in some cases, injuries accompany due to wrong copying. Further, the fact that a user sincerely copies a standard exercise video by the services presupposes that the user would not get lazy, and it is possible only to check that the user watched the video, so there is a limitation that it is actually difficult to determine that the video was helpful for the health of the user.

As a background technology for improving such a home training service, there is a technology related to measuring poses of a human body using a computer vision technology. By using a pose measurement technology, it is possible to extract information about 3D shape and poses of a human body from images taken by common cameras even without using a specific scanner. Accordingly, a method of comparing human body pose information extracted from standard poses of experts and human body pose information extracted from copying actions by users with each other is used in home training services. There is an advantage that it is possible to quantitatively give grades to concordance of poses and automatically or manually give feedback on the basis of the grades.

However, it is totally responsible to service suppliers to provide standard poses in home training services known in the art. That is, it is required to contact experts who are suitable for users to copy, for example, a fitness trainer, a Pilates teacher, a yoga teacher, or the like, obtain standard action videos from the experts, extract human body pose information from the standard pose videos, process the human pose information into action information to function as service programs that the users can copy, and store the action information in a storage of a service server in advance.

### SUMMARY OF THE DISCLOSURE

The present disclosure has been made to overcome the limitations of the existing home training services. In the existing home training services described above, service providers have to continuously actively supply new contents by continuously planning exercise programs, contacting experts for corresponding exercise programs, and making contents including standard poses. However, service users who are unspecified persons can only select and perform the contents.

However, there is a limitation in speed of supplying contents by the service providers. Accordingly, service providers have a limitation that an excessive operation load is applied. Even if demands for the services increase and more various experts want to provide the service providers with various programs, there is a high possibility for the service providers to experience a bottleneck in supplying the programs. Such a limitation necessarily remains as long as the existing home training service technology and service systems using this technology are constructed in a closed service environment in which contents providers, service providers, and service users are clearly discriminated.

In order to overcome the limitations described above, the present disclosure provides a new method of making it possible to provide a home training service in an open type by making it possible to provide a home training service on the basis of a video selected by a user, and an embodiment of implementing the method.

In order to achieve the objectives described above, a method of providing a user pose guide using a terminal device according to an embodiment of the present disclosure may include: inputting video selection information and obtaining a first video, in which a first action has been recorded, on the basis of the video selection information; obtaining the first action related to the first video; displaying the first video; obtaining a second video in which a second action copying the first action has been recorded; comparing the first action and the second action; and displaying pose guide information on the basis of the comparison.

The obtaining of a first video on the basis of the video selection information may include: connecting with a server device; receiving interface information from the server device; displaying interface information for inputting the video selection information; inputting and transmitting the video selection information to the server in accordance with the interface information; and receiving the first video corresponding to the video selection information from the server device.

The video selection information may be information about selecting one of at least one video choice included in the interface information provided from the server device.

The video selection information may include at least one item of information used for the server device to obtain the first video from a content provider of the first video.

The video selection information may include at least one of: communication information identifying the content provider of the first video in a communication network; identification information used for the content provider to identify the first video; communication protocol information used to obtain the first video; and communication authentication information including at least one of an ID, a password, and an authentication key that are required to obtain the first video from the content provider.

The obtaining of a first video on the basis of the video selection information may include: displaying interface information for selecting at least one video stored in a storage; inputting the video selection information in accordance with the interface information; and obtaining the first video corresponding to the video selection information from the storage.

The method may further include: extracting the first action from the first video by means of a first action extractor; and extracting the second action from the second video by means of a second action extractor, wherein the first action and the second action may be information about actions showing pose variation of an object in order of time.

At least one of the first action extractor and the second action extractor may be operated by a pose extraction algorithm, the pose extraction algorithm may receive a video and outputs an action, and may operate, including: extracting at least one video frame from a video; generating at least one item of object joint information on the basis of the at least one video frame; generating at least one item of object skeleton information on the basis of the at least one video frame; generating at least one item of object pose information by combining the at least one item of object joint information and the at least one item of object skeleton information; and extracting an action by continuously combining the at least one item of object pose information.

The pose extraction algorithm may operate, further including normalizing the object pose information, and the normalization may mean standardizing the object pose information by applying geometric transformation, which corresponds to at least one of enlarging, reducing, rotating, inversing, and skewing, to at least a portion of the object pose information using at least one vector.

At least one step of the pose extraction algorithm may be operated by an artificial neural network.

The displaying of the first video may include: converting object pose information, which is included in the first action, into a pose guide graphic element which is a reconstructed shape of an object; and displaying the pose guide graphic element with the first video.

The first action extractor may operate in the server device.

The comparing of the first action and the second action may include obtaining at least one item of pose comparison information by comparing at least one item of object pose information included in the first action and at least one item of object pose information included in the second action using a comparison algorithm, the at least one item of pose comparison information may be information showing at least one of the degree of concordance and a difference vector of the second action to the first action, and the pose guide information may be generated on the basis of the at least one item of pose comparison information.

The comparison algorithm may include normalizing the object pose information included in the second action by applying geometric transformation, which corresponds to at least one of enlarging, reducing, rotating, inversing, and skewing, to at least a portion of the object pose information included in the second action using at least one vector.

The displaying of pose guide information may include displaying the pose guide information through a display of the terminal device by visualizing and overlaying the pose guide information on at least one of the first video and the second video.

The displaying of pose guide information may include making the pose guide information into a voice and displaying the voice through a speaker device of the terminal device.

A plurality of first actions may have been recorded in the first video, the method may further include selecting at least one item of action discrimination information including information that discriminates times at which actions appear in the first action and information that discriminates objects taking actions in the first video, and the obtaining of a first action related to the first video may obtain only a first action identified on the basis of the action discrimination information from a plurality of first actions related to the first video.

In order to achieve the objectives described above, a method of providing a user pose guide using a terminal device according to an embodiment of the present disclosure may include: inputting video selection information and obtaining a first video, in which a first action has been recorded, on the basis of the video selection information; extracting at least one video frame from the first video; generating at least one item of object joint information on the basis of the at least one video frame; generating at least one item of object skeleton information on the basis of the at least one video frame; generating at least one item of object pose information by combining the at least one item of object joint information and the at least one item of object skeleton information; extracting a first action by continuously combining the at least one item of object pose information; converting object pose information, which is included in the first action, into a pose guide graphic element which is a reconstructed shape of an object; and displaying the pose guide graphic element with the first video.

In order to achieve the objectives described above, a method of providing a user pose guide using a server device according to an embodiment of the present disclosure may include: receiving video selection information for a first video from a terminal device; requesting the first video information from a content provider on the basis of the video selection information; obtaining the first video from the content provider: obtaining a first action related to the first video by means of a pose extraction algorithm; and transmitting the first video and the first action to the terminal device.

In order to achieve the objectives described above, a terminal device providing a user pose guide according to an embodiment of the present disclosure may include: a first input unit configured to receive input of video selection information; a video obtainer configured to obtain a first video on the basis of the video selection information: a first processing unit configured to obtain a first action related to the first video; a second input unit configured to obtain a second video in which a second action copying the first action has been recorded; a second processing unit configured to obtain a second action related to the second video; a third processing unit configured to generate pose guide information by comparing the first action and the second action; a display configured to display at least one of the first video, the first action, the second video, the second action, and the pose guide information; a processor configured to control operation of the above components; and a memory connected to the processor.

According to embodiments of the present disclosure to be described below and implement methods that are not limited by the embodiments and can be freely changed within the spirit of the present disclosure, there is an effect of providing an open service platform that enables a user to freely and independently select a content provider without depending on service providers when using a home training service.

The open service platform is served through the internet, etc., and provides an effect that when the user selects and inputs in person a video to use for home training, actions based on artificial intelligence, etc. are extracted by the open service platform and home training can be provided to the user on the basis of the extraction of the actions.

Accordingly, when a freelancer exercise teacher, an exercise video expert creator, or the like freely uploads a home training video, the user can select the training video in persons and exercises even without a plan or interference by the service provider, so there is a useful effect that a technical method and such a system that can solve bottleneck of the content supply speed described above can be provided by enabling more direct connection between providers of various exercise contents and consumers.

Further, since the types of videos that the user can determine are not limited, there is an effect that it is possible to provide users with not only exercise training videos, but videos that requires copy of choreographies such as K-POP dance videos using the home training service, and it is also possible to provide users with a training opportunity through action recognition and comparison in the same service.

### BRIEF DESCRIPTION OF THE DRAWINGS

FIG. 1 is a conceptual view showing a user pose guide service that uses a terminal device according to an embodiment of the present disclosure;

FIG. 2 is an action conceptual view of a service for providing a user pose guide by a first embodiment of the present disclosure;

FIG. 3 is an exemplary view of an interface that can be displayed on a terminal device on the basis of interface information by the first embodiment of the present disclosure;

FIG. 4 is a flowchart in which an action extractor according to an embodiment of the present disclosure extracts object pose information;

FIG. 5 is an exemplary view of a first action selection interface that can be displayed on a terminal device by interface information by an embodiment of the present disclosure;

FIG. 6 is a flowchart showing service operation by the first embodiment of the present disclosure;

FIG. 7 is an exemplary view of a service interface that can be displayed on a terminal device by interface information by the first embodiment of the present disclosure;

FIG. 8 is an operational conceptual view of a service for providing a user pose guide by a second embodiment of the present disclosure;

FIG. 9 is an exemplary view of an interface that can be displayed on a terminal device on the basis of interface information by the second embodiment of the present disclosure;

FIG. 10 is an operational conceptual view of a service for providing a user pose guide by a third embodiment of the present disclosure;

FIG. 11 is an exemplary view of an interface that can be displayed on a terminal device on the basis of interface information by the third embodiment of the present disclosure;

FIG. 12 is an action conceptual view of a service for providing a user pose guide by a first embodiment of the present disclosure; and

FIG. 13 is a block diagram of a terminal device for providing a user pose guide of the present disclosure.

### DESCRIPTION OF EXEMPLARY EMBODIMENTS

The present disclosure may be modified in various ways and implemented by various exemplary embodiments, so that specific exemplary embodiments are shown in the drawings and will be described in detail. However, it is to be understood that the present disclosure is not limited to the specific exemplary embodiments, but includes all modifications, equivalents, and substitutions included in the spirit and the scope of the present disclosure.

Terms used in the specification, “first”, “second”, etc., may be used to describe various components, but the components are not to be construed as being limited to the terms. The terms are used only to distinguish one component from another component. For example, the “first” component may be named the “second” component, and vice versa, without departing from the scope of the present disclosure. The term “and/or” includes a combination of a plurality of related and described items or any one of a plurality of related and described terms, and is not exclusive unless stated otherwise. When items are enumerated in the specification, it is only exemplary description for easily explaining the spirit and available implementation methods of the present disclosure, and accordingly, it is not intended to limit the range of embodiments of the present disclosure.

It is to be understood that when one element is referred to as being “connected to” or “coupled to” another element, it may be connected directly to or coupled directly to another element or be connected to or coupled to another element, having the other element intervening therebetween. On the other hand, it should to be understood that when one element is referred to as being “connected directly to” or “coupled directly to” another element, it may be connected to or coupled to another element without the other element intervening therebetween.

Terms used in the present specification are used only to describe specific exemplary embodiments rather than limiting the present disclosure. Singular forms are intended to include plural forms unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

Unless defined otherwise, it is to be understood that all the terms used in the specification including technical and scientific terms has the same meaning as those that are understood by those who skilled in the art. It will be further understood that terms defined in dictionaries that are commonly used should be interpreted as having meanings that are consistent with their meanings in the context of the relevant art and will not be interpreted in an idealized or overly formal sense unless expressly so defined herein.

In the description of the present disclosure in the specification, embodiments may be described or exemplified in terms of described functions or unit blocks that perform the functions. The blocks may be expressed as one or a plurality of devices, units, modules, parts, etc. in the specification. The blocks may be implemented in a hardware type by a method of implementing one or a plurality of logic gates, integrated circuits, processors, controllers, memories, electronic parts, or information processing hardware not limited thereto. Alternatively, the blocks may be implemented in a software type by a method of implementing application software, operating system software, firmware, or information processing software not limited thereto. One block may be implemented into a plurality of separate blocks that performs the same function, and, on the contrary, one block for simultaneously performing the functions of a plurality of blocks may be implemented. The blocks may be physically separated or combined on the basis of any reference. The blocks may be implemented to operate in an environment in which their physical positions are not specified and they are spaced apart from each other by a communication network, the internet, a cloud service, or a communication method not limited thereto. All the implementation methods described above are included in the area of various embodiments that can be taken by those skilled in the field of information communication technology to implement the same spirit, so the following detailed implementation methods should be construed as being included in the spirit of the present disclosure described in the specification.

Hereinafter, exemplary embodiments of the present disclosure will be described in more detail with reference to the accompanying drawings. In order to facilitate the general understanding of the present disclosure in describing the present disclosure, through the accompanying drawings, the same reference numerals will be used to describe the same components and an overlapped description of the same components will be omitted. Further, several embodiments are not exclusive to each other and presupposes that some embodiments can be combined with one or more other embodiments to achieve new embodiments.

Basic Concept

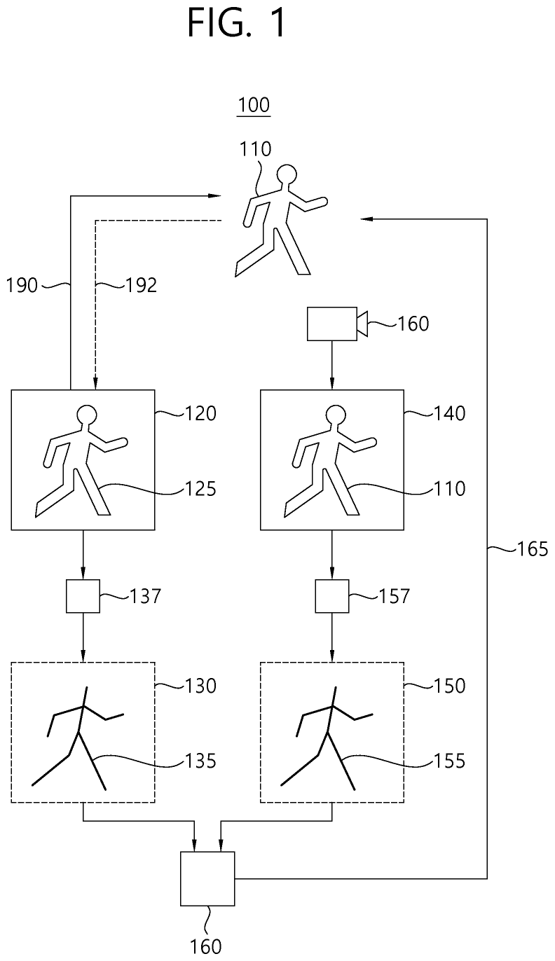

FIG. 1 is a conceptual view showing a user pose guide service that uses a terminal device according to an embodiment of the present disclosure.

In the service 100 of an embodiment shown in FIG. 1, a service user 100 may be a person who intends to perform a program composed of predetermined actions of predetermined continuous poses at a remote place, and for example, may be a person who exercises using a home training service.

The service user 110 may be provided with a standard video 120 (190). The standard video 120 is obtained by recording actions done by an expert 125 as a standard and may be an exercise training video obtained by capturing the expert 125 who shows fitness exercise, strength training, yoga, Pilates, a dance, a golf swing, and other body movement of which the poses can be recognized and that requires to follow standard poses. Accordingly, it is expected that the user 110 who uses the service watches the standard video 120 through a display device, etc. (190) and exercises by copying the actions that the expert 125 takes in the standard video 120.

Standard action information 130 may be generated for the standard video 120. The standard action information 130 may include standard pose information 135. The standard pose information 135 may show poses that the expert 125 takes into computer-readable type of data.

In a preferred embodiment of the present disclosure, the standard pose information 135 may be composed of absolute or relative position information of specific joints of at least one human body and directional vector information connecting the joints. In the specification, the position information of the joints is referred to as human body joint information and the directional vector information as human body skeleton information. Further, information showing poses of a human body by combining the human body joint information and the human body skeleton information is referred to as human body pose information. That is, the standard pose information 135 may be the type of human body pose information.

The standard pose information 135 can be obtained by inputting the standard video 120 into a first pose extraction algorithm 137. The first pose extraction algorithm is an algorithm for extracting the human pose information from a given video such as the standard video 120 and the implementation method thereof will be described below.

Meanwhile, information about the poses that the user takes can be recorded (115). The recording (115), according to a preferred embodiment of the present disclosure, may be performed in real time, but if not necessarily so, it does not matter. A user video 140 can be obtained as the result of the recording (115). Further, user action information 150 may be generated for the user video 140. The user action information 150 may be included in user pose information 155 obtained by inputting the poses that the user 110 takes into a second pose extraction algorithm 157.

The first pose extraction algorithm 137 and the second pose extraction algorithm 157, depending on embodiments of the present disclosure, may be the same, but may be different as long as they keep their objectives. Similarly, it does not influence achievement of the effects of the present disclosure that the implementation places and times of two algorithms 137 and 157 are the same or different.

The standard action information 130 and the user action information 140 may be compared with each other (160). That is, it is possible to evaluate user pose information 145 included in the user action information 140 on the basis of the standard pose information 135 included in the standard action information 130. The comparing method will be described below. Through the comparing, as a result, it is possible to easily known that the degrees of concordance of the poses taken by the expert 125 and the poses taken by the user 110 can be compared.

As the result of comparing (160), pose guide information may be generated and displayed to the user (165). The pose guide information may be derived on the basis of the result of estimating a change that should be applied to the user action information 140 to be matched with the standard action information 130. For example, when the rotation angle of upper arms of the user 110 is smaller than that of the expert 125, it may be a person-recognizable display method that requests to supplement of the rotation angle of the upper arm, but is not limited to this example.

The user 110 provided with display (165) of the pose guide information can recognize what action he/she has to take to copy the action of the expert 125 better while watching the standard video 120 (190), so the service 100 may be used as an objective of a home training service, depending on embodiments of the present disclosure.

According to the present disclosure, a function that enables the user 110 to select the standard video 120 in person is provided. In more detail, it is possible to provide video selection information 192 enabling the user to specify and select the standard video. As a result, the present disclosure can provide an effect that enables the user 110 to use the service 100 in the type in which the content provider of the standard video 120 is not limited.

### First Embodiment and Application Embodiment

Hereafter, a first embodiment that corresponds to a preferred implementation method of the present disclosure but does not limit the implementation method of the present disclosure is described. Further, embodiments that can be applied by the discretion of appliers who are those skilled in the art when implementing the first embodiment are also described.

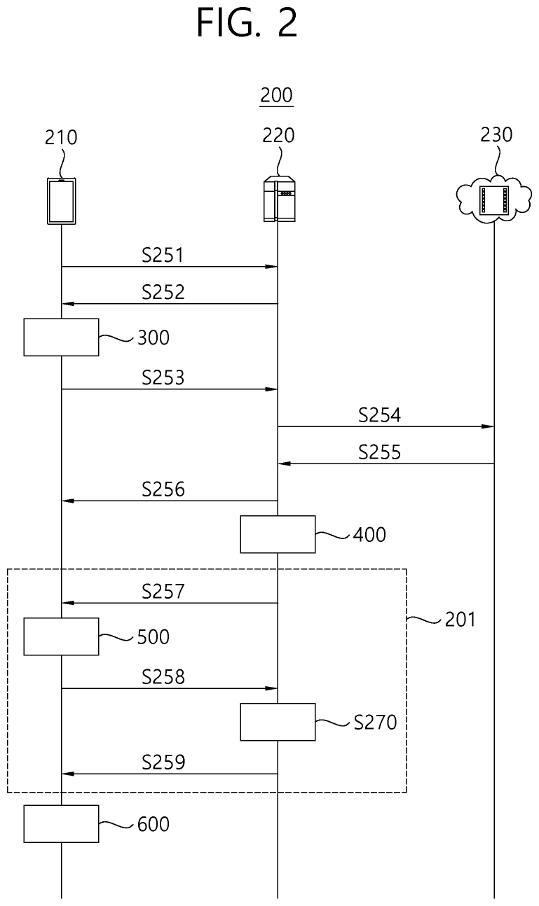

FIG. 2 is an action conceptual view of a service for providing a user pose guide by a first embodiment of the present disclosure. A service system 200 shown in FIG. 2, for example, is for providing a home training service by providing a pose guide according to the present disclosure and may include a terminal device 210, a service device 220, and a content provider 230.

The terminal device 210 may be an information communication terminal device. The terminal device 210, depending on implementation methods of the present disclosure, may be a terminal device corresponding to any one of personal information communication terminal devices including a smartphone, a tablet computer, a personal computer (PC), a laptop, and a smart TV. Further, the terminal device may be a terminal device that can take information communication by connecting with the server device 220 through a communication means such as IMT-2000, LTE, 5G, Wi-fi, LAN, or near field communication.

In the following description of the first embodiment that does not limit an implementation method of the present disclosure, it is assumed that the terminal device 210 is a mobile information communication device that is operated by a user who intends to use a home training service (hereafter, a service) such as a smartphone. The user, for example, may be considered as being the same as the user 110 shown in FIG. 1, and in the description of the present embodiment, it is assumed that the user intends to acquire a first video, which is the video of an exercise expert whom he/she intends to copy, and use the service.

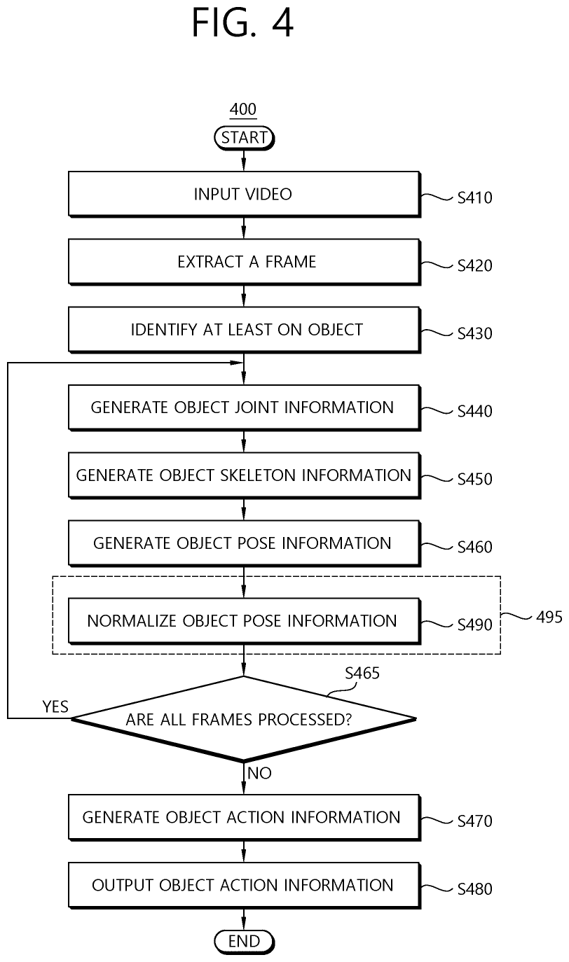

In the following first embodiment that does not limit an implementation of the present disclosure, the server device 220 is a server installed to provide the service and may be a server configured to obtain the first video in response to a request from the terminal device 210 and provide pose guide information on the basis of the first video. The server device 220 may be configured to include a function that supplies the first video to the terminal device 210 through a world wide web using a single file, or a streaming packet, or a similar digital data exchange method. Further, the server device 220 may be configured to include the function of a first action extractor that extracts action information from the first video, and the function of the first action extractor will be described below with reference to reference numeral in FIG. 2, and FIG. 4.

The server device 220 may be an information communication service server. The server device 220 may be implemented as a single server computer device, depending on implementation methods of the present disclosure. However, depending on other implementation methods, even though the server device is implemented by a plurality of server devices, a cloud server, or a processing process distributed to at least one server and at least one client, it does not matter in achievement of the objectives of the present disclosure.

The content provider 230 may be a content provider that usually handles videos. The content provider 230, depending on implementation methods of the present disclosure, may be a supplier that supplies digital video information through a world wide web using a single file, or a streaming packet, or a similar digital data exchange method, and particularly, may be considered as a storage server device of a supplier that the supplier has installed to supply the digital video. Of course, depending on implementation methods of the present disclosure, it is apparent that the supplier may be replaced with any implementation methods as long as it is a means for supplying a target video that is used for the core configuration of the present disclosure.

In the following description of the first embodiment that does not limit an implementation of the present disclosure, the content provider 230 is considered as a storage server device that keeps and supplies video contents of experts that are used for the service, for example, a content that can be used as the standard video 120 by the expert 125.

When the service is started on the terminal device 210 by the user, the terminal device 210 can connect with the server device 220 that provides the service (S251). In response to the connection (S251), the server device 220 can provide interface information to the terminal device 210 (S252).

The method of configuring the connection (S251) and the type of the interface information that is provided (S252) are not limited. According to an implementation of the present disclosure, the terminal device 210, for example, may connect with the server device 220 by built-in web browser software on the basis of an internet protocol (IP) (S251) and may provide information about a web service interface including Hypertext Markup Language (HTML) that can be displayed in the web browser software in response to the connection (S251) (S252). As another example, the terminal device 210 may connect with the server device 220 in a peculiar communication method by built-in application software (S251) and may provide information that gives an instruction to display a user interface included in the application software in response to the connection (S251) (S252). Further, various applied implementation methods known that are known in the art or will be newly developed may be applied to implement an information communication service by common terminal-server application software.

When the interface information is received (S252), a corresponding interface 300 may be displayed on the terminal device 210.

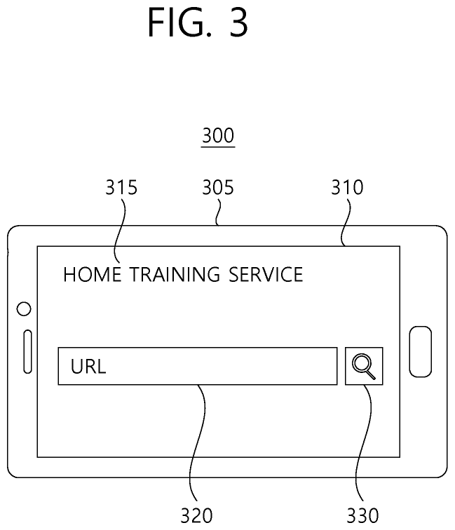

This process is further described hereafter with reference to FIG. 3. FIG. 3 is an exemplary view of an interface that can be displayed on a terminal device on the basis of interface information by the first embodiment of the present disclosure. In the description of the first embodiment that does not limit the implementation method of the present disclosure, the interface 300 may have an objective that designates a first video that the user intends to use for the home training service.

The interface 300 may be displayed through a display 310 of a terminal device 305. The interface 300 may include a function of inputting video selection information for acquiring the first video (S320) and a function of instructing the server device 220 to acquire the first video (S330). The interface may further include a display item 315 showing the objective of the interface, for example, a display item showing the name of the service. However, these functions of the interface 300 are examples, and functions of the interface 300 may be added, changed, or removed as long as they keep the technical objectives of the present disclosure.

The video selection information may include at least one time of information that is used for the server device 220 to obtain the first video from the content provider 230 of the first video. In the description of the first embodiment that does not limit the implementation method of the present disclosure, the video selection information may mean a uniform resource locator (URL) that is used to acquire the first video content of the content provider 230 through an internet protocol.

In more detail, the video selection information may include communication information such as an IP address and a domain name that are used to identify the content provider 230 of the first video in a communication network. The video selection information may include identification information such as a web page address, a database ID, and other identification symbols on the service that the content provider 230 uses to identify the first video. The video selection information may include information indicating a communication protocol such as a hypertext markup language (http) or a file transfer protocol (ftp) that is used to obtain the first video. The video selection information may include communication authentication information including at least one of an ID, a password, and an authentication key that are used to obtain the first video from the content provider. The communication authentication information can be used when predetermined authentication is required such as login or API authentication to acquire the first video from the content provider 230. Accordingly, even though the communication authentication information is differently used as a set of certain communication authentication information that is known in the art or will be newly developed to be used for the purpose of determining a data reception qualification using an information communication network, it apparently does not influence achievement of the objectives of the present disclosure.

As an example that is easy for a common engineer to understand, the video selection information may include an http URL such as “http://www.*******.com/12345678”. It may be considered that the communication information is exemplified as a domain address (“www.*******.com”) indicating a content provider in the URL, the identification symbol is exemplified as an additional address (“/12345678”) indicating a specific video in the URL, and the information of the communication protocol is exemplified as a protocol indictor (“http://”) of the URL. Further, the video selection information may further include a unique authentication key of a video download API that is permitted by the content provider separately from the URL.

Referring to FIG. 2 again, the user can input the video selection information through an input function (320) of the interface 300 and transmit the video selection information to the server device using the indication function (330) (S253).

The server device 220 can connect with a server of the content provider 230 (S254) on the basis of the received video selection information (S253), and obtain a first video that the user wants (S255). Accordingly, the server device 220 can provide the first video to the terminal device 210 (S256).

At least one or, depending on cases, several objects may have been recorded in the first video. In the description of the first embodiment that does not limit the implementation method of the present disclosure, the object may be a human body, and accordingly, the first video may be, as described above, the standard video 120 by the expert 125 shown in FIG. 1.

The server device 220 may be configured to extract a first action from the first video through the first action extractor, using the first video. According to an embodiment of the present disclosure, the first action extractor may include at least one artificial intelligence model such as machine learning, which has been trained in advance by supervised learning or unsupervised learning, or an artificial neural network. Depending on embodiments of the present disclosure, the artificial intelligence model may be implemented as a convolutional neural network (CNN) based on convolution. The first action extractor may operate entirely or partially in dependence on the at least one artificial intelligence model.

FIG. 4 is also referred to in the following description. FIG. 4 is a flowchart in which an action extractor according to an embodiment of the present disclosure extracts object pose information. The action extractor may receive a video such as the first video as input (S410), obtain at least one video frame by dividing the video into frames (S420), identify an object (body) including at least one human body from each of the video frames (S430), generate at least one item of object joint information by analyzing the recognized object (S440), generate at least one item of object skeleton information on the basis of the at least one video frame by analyzing the recognized object (S450), and generate object pose information by combining the at least one item of object joint information and the at least one item of object skeleton information (S460).

In a more applied embodiment 495 of the present disclosure, the object pose information may be normalized after generated (S490). The normalizing may mean standardizing the object pose information by applying geometric transformation, which corresponds to at least one of enlarging, reducing, rotating, inversing, and skewing, to at least a portion of the object pose information using at least one vector.

The normalizing may be for compensating for a fluctuation due to the size of the object, that is, a recorded human body and a fluctuation due to the recording method when the object is recorded in the input video. For example, the normalizing may have an objective for offsetting so-called Rotate, Scaling, and Transform (RST) changes such as rotating, enlarging, reducing, and angle changing in the object pose information. Further, the normalizing may include a process of converting the object pose information into human body pose information having standardized arm length and leg length by geometrically transforming the object pose information. As another example, the normalizing may include a process of correcting the object to be aligned with at least one reference point of an X-axis (left-right), a Y-axis (front-rear), and a Z-axis (up-down) by estimating transformation on the X-axis, the Y-axis, and the Z-axis when the object appears in the input video and by geometrically offsetting the transformation.

The normalizing may be performed including at least one geometric transform function including rigid transform, affine transform, and projection transform to achieve the objectives.

The normalizing may be configured to include, besides the implementation method described above, a certain information correction process of processing the object pose information to be able to be easily used to correspond to the objectives of the present disclosure by standardizing the object pose information.

The object pose information may be repeatedly generated for every continuous frames (S465). The at least one item of object pose information generated for the object can be used to generate object action information for the object by continuously combining the object pose information over time (S470).

The object action information can be output as the processing result of the action extractor (S480). Accordingly, the object action information may be considered as the first action that is extracted from the first video by the first action extractor.

Referring to FIG. 2 again, the first action extracted by the first action extractor 400, as described above, may include action-related information showing pose variation of an object appearing in the first video, that is, the expert in order of time. When the first action is extracted, the first action can be transmitted from the server 230 to the terminal device 210 (S259).

The service system 200 according to the first embodiment of the present disclosure may be configured such that two or more objects can be recorded in the first video and accordingly two or more first actions can be extracted from the first video. In this case, actions 201 corresponding to the applied first embodiment of the present disclosure may be further included.

In the applied first embodiment that does not limit the implementation method of the present disclosure, the first action extractor 300 may be configured to extract a first action for each of the plurality of objects. In order to generate a plurality of first actions for the plurality of objects, a certain step in the processing flowchart of the first action extractor 400 shown in FIG. 4 may be configured to be repeatedly performed in the unit of object, and may be configured to extract a plurality of first actions from a plurality of objects by means of other implementation methods.

The plurality of first actions may be discriminated by action discrimination information including information that discriminates the times at which actions appear and information that discriminates objects taking actions in the first video. For example, the action discrimination information may be information configured to indicate a specific exercise expert who appears at a specific hour of several exercise experts who appear in the first video.

In the applied first embodiment that does not limit the implementation method of the present disclosure, the service 200 may allow a user to select one of the plurality of first actions. Accordingly, the server device 220 can provide at least one item of action discrimination information that discriminates a plurality of first actions included in the first video to the terminal device (S257).

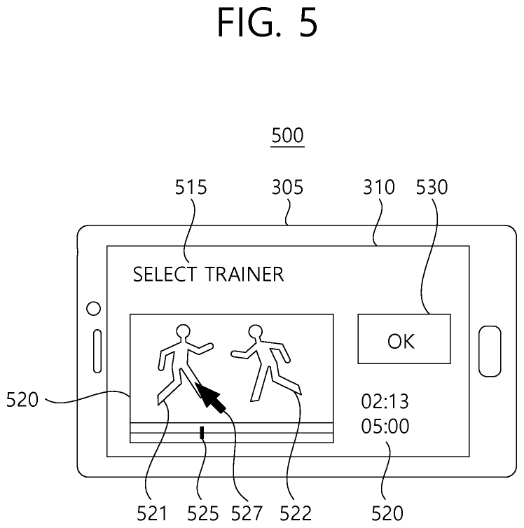

This is further described with reference to FIG. 5. FIG. 5 is an exemplary view of a first action selection interface that can be displayed on a terminal device by interface information by an embodiment of the present disclosure. The interface 500 may have an objective of enabling a user to select action discrimination information that indicates a specific first action, which the user will take as a copying target, of at least one item of action discrimination information provided as described above (S527).

The interface 500 may be displayed through the display 310 of the terminal device 305. According to an embodiment of the present disclosure, the interface may include a function of displaying the first video (5200, a function of being able to search for the first video in a time direction such as a play bar 525 or a time indicator 526, a selection cursor function provided to be able to select one of a plurality of objects appearing in the first video (527), and a function of determining selection of action discrimination information according to selection time and an object by the functions (530). The interface may further include a display item 515 showing the objective of the interface. However, these functions of the interface 500 are examples, and functions of the interface 500 may be added, changed, or removed as long as they keep the technical objectives of the present disclosure.

According to the interface 500 shown in FIG. 5, a user can select first exercise to copy by checking appearance of an exercise expert who perform desired first exercise while seeing the first video using the play bar 525, by selecting an object identified for the exercise experts by clicking the exercise expert, and then by selecting one item of action discrimination information according to selection of corresponding time and object.

However, the embodiment described above does not limit an implementation method of the present disclosure, so the implementation method of the interface 500 may be variously changed. For example, the interface 500 may be implemented to provide a list showing the provided plurality of items of action discrimination information (S527) in the type of a scrollable list or a drop-down list. Further, even if any other interface is provided, it does not influence achievement of the objectives of the present disclosure as long as they have a function of selecting action discrimination information.

Information about selection of the action discrimination information in the terminal device 210 can be transmitted to the server device 220 (S258). The information that is transmitted (S258), depending on embodiments, may be an index for identifying one of the plurality of action discrimination information or may be the selected action discrimination information itself. The server device 220 may be configured to select only a first action that is identified on the basis of the selected action discrimination information (S270) and to transmit information about the selected first action to the terminal device 210 (S259).

By the operation process shown in FIG. 2, the terminal device 210 can obtain the first video (S256) and obtain information about the first action (S259). Accordingly, the terminal device 210 may be configured to perform a service operation 600 on the basis of them.

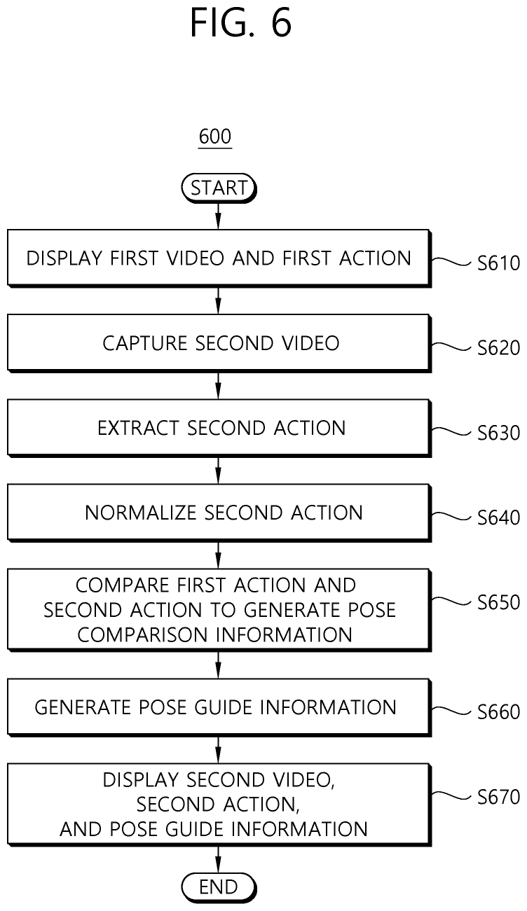

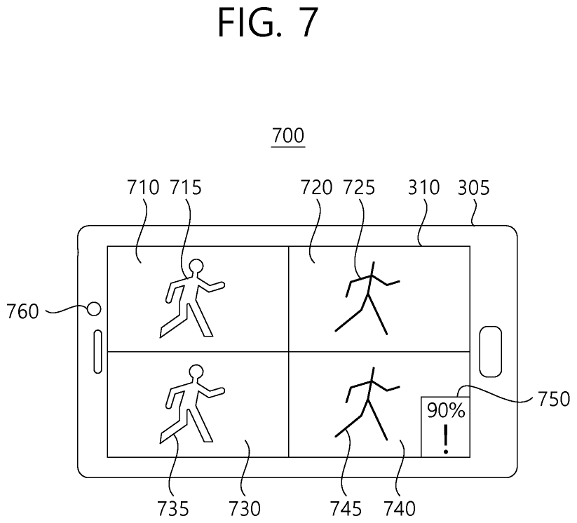

FIG. 6 is a flowchart showing service operation by the first embodiment of the present disclosure. Further, FIG. 7 is an exemplary view of a service interface that can be displayed on a terminal device by interface information by the first embodiment of the present disclosure. The following description refers to these two figures.

In the description of the first embodiment that does not limit the implementation method of the present disclosure, the service interface 700 may have an objective of implementing the home training service operation 600 that helps a user successfully copy the first action shown in the first video.

The interface 700 may be displayed through the display 310 of the terminal device 305. The interface 700 may include a function of displaying the first video (710), a function of displaying the first action (720), a function of displaying a second video (730), a function of displaying a second action (740), and a function of displaying a pose guide (750). In a preferred embodiment of the present disclosure, the user can take a second action copying the first action while observing display of the first video (710) and display of the first action (720), can check himself/herself taking the second action from the shape 735 of the user shown in display of the second video (730) and display of the second action (740), and can obtain information enabling the user to more successfully copying the first action from display of the pose guide (750).

However, these functions of the interface 700 are examples, and functions of the interface 700 may be added, changed, or removed as long as they keep the technical objectives of the present disclosure. Further, at least one recording device 760 may be installed in the terminal device 305 displaying the interface 700.

The obtained first video can be displayed to the user. Further, depending on embodiments, the first video may be displayed with the first action (S610). The first video and the first action may be displayed by the first video display function (710) of the interface and the first action display function (720) of the interface 700, respectively.

Display of the first action may be performed by a procedure including a step of converting object pose information, which is included in the first action, into a graphic element which is a reconstructed shape of an object. For example, when object pose information of the present disclosure is composed of object joint information and object skeleton information, as in the embodiment described above, the object joint information and the object skeleton information may be visualized (725) and provided to a user, as shown in the first action display function (720) of FIG. 7.

The first video display function (710) and the first action display function (720) may be separated from each other in the interface 700, or, depending on embodiments, they may partially or entirely overlap each other. For example, in a modified embodiment of the present disclosure, the first action display function (720) may be displayed to be overlaid on the first video display function (710).

As the first video and the first action are displayed, the user can observe and attempt to copy the first action of the expert 715 recorded in the first video. Display the first action together provides an effect of helping the user copy the first action shown in the first video better.

In the specification, the action that the user takes by observing and copying the first action is referred to as a second action. The second action of the user copying the first action is recorded by the recording device 760, whereby a second video can be generated (S6200. The recording device 760, according to an embodiment, may mean a camera attached to the terminal device 305. However, according to another embodiment, even if any recording device that can be disposed inside or outside the terminal device 305 and can be connected thereto in a wired or wireless type is used, it does not influence achievement of the objectives of the present disclosure.

The second active can be extracted from the second video by a second action extractor (S630). The second action extracted by a second action extractor, as described above, may include an object appearing in the second video, that is, information about actions showing pose variation of the user 735 in order of time. In the description of the first embodiment that does not limit the implementation method of the present disclosure, the second action extractor may operate in the terminal device 305. According to this embodiment, the second video recorded by the recording device 760 may be input to the second action extractor in the terminal device 305.

The operation method of the second action extractor, according to a preferred embodiment of the present disclosure, may be the same as that of the first action extractor. Accordingly, all the embodiments of the first action extractor described above with reference to FIG. 4 may be applied in the same way to the second action extractor. However, according to another embodiment of the present disclosure, the second action extractor may be implemented in a structure that is similar to, but different from that of the first action extractor. For example, when the first action extractor is driven in a server device, it may be difficult to implement the same action extraction function in a terminal device, so another implementation method that can extract the second action in the data type of the first action may be applied to the second action extractor.

Further, according to another embodiment of the present disclosure, the second action extractor may be configured to operate at a remote place such as the server device rather than operate in the terminal device. In this case, a step of transmitting the second video from the terminal device to the server device and a step of receiving information about the second action from the server device may be added to the implementation result of the present disclosure in order to extract the second action from the second video. Further, depending on embodiments, the first action extractor and the second action extractor may mean one function device that operate in response to different types of input.

When the first action and the second action are obtained, it is possible to generate pose guide information by comparing the two actions (S640). Comparing the two actions, as described above with reference to FIG. 1, may be performed by a method of evaluating the object pose information included in a second action corresponding to a copying action of a user 735 on the basis of the object pose information included in a first action corresponding to a copying action of an expert 715.

In the description of the first embodiment that does not limit the implementation method of the present disclosure, the comparing may be achieved by comparing the first action and the second action in the unit of frame. In more detail, the comparing may be achieved by, in each frame, showing the object joint information and the object skeleton information constituting the object pose information of the first action into first vector information, showing the object joint information and the object skeleton information constituting the object pose information of the second action into second vector information, and then obtaining the difference of the second vector information from the first vector information through calculation.

When obtaining the difference between the first vector information and the second vector information, it is possible to obtain the difference by separating the information in the unit of joint or the unit of skeleton. For example, it is possible to derive how much the second action of the user 735 is different from the first action of the expert 715 in upper arms by comparing a first segment vector showing skeleton information corresponding to the upper arms in the object pose information of the first action and a second segment vector showing the same information in the second action with each other.

The calculation of the difference of between the items of vector information may be performed in a previously designated type by an algorithm or may be performed by a method of obtaining a resultant effect of the calculation by applying an advanced information processing function such as an artificial neural network. Further, even if any operation technique that is known in the art or will be newly developed to calculate the difference between the items of vector information is applied, it does not influence achievement of the objectives of the present disclosure.

Before the difference is calculated, the object pose information included in the second action may be normalized. The normalizing may mean standardizing the object pose information by applying geometrical deformation, which corresponds to at least one of enlarging, reducing, rotating, inversing, and skewing, to at least a portion of the object pose information using at least one vector.

The normalizing may be for compensating for a fluctuation due to the size of the object, that is, a recorded human body of a user and a fluctuation due to the recording method when the object is recorded in the second video. In particular, since the environment of recording the first video and the environment of recording the second video are different, the normalizing may have an objective of suppressing, by compensating for the difference, that the second action copying the first action is evaluated as being unexpectedly made different due to external factors, such as a difference in body size between the user and the expert 715, a difference in height, a difference in available joint range, the distance from a recording device, a lens angle of the recording device, and the resolution of the recording device.

For example, the normalizing may have an objective for offsetting so-called Rotate, Scaling, and Transform (RST) changes such as rotating, enlarging, reducing, and angle changing in the object pose information. Further, the normalizing may include a process of converting the object pose information into human body pose information having standardized arm length and leg length by geometrically transforming the object pose information. As another example, the normalizing may include a process of correcting the object to be aligned with at least one reference point of an X-axis (left-right), a Y-axis (front-rear), and a Z-axis (up-down) by estimating transformation on the X-axis, the Y-axis, and the Z-axis when the object appears in the input video and by geometrically offsetting the transformation.

The normalizing may be performed including at least one geometric transform function including rigid transform, affine transform, and projection transform to achieve the objectives.

The normalizing may be configured to include, besides the implementation method described above, a certain information correction process of processing the object pose information to be able to be easily used to correspond to the objectives of the present disclosure by standardizing the object pose information.

The difference between the first action and the second action, in accordance with an embodiment of the present disclosure, may be derived as pose comparison information including at least one of the degree of concordance between the first vector and the second vector and a difference vector of the second vector from the first vector. Pose guide information can be generated from the pose comparison information (S660).

The pose guide information, in the description of the first embodiment that does not limit the implementation method of the present disclosure, may be derived in various types of information that can help induce the second action of the user to come close to the first action of the expert 715. For example, the pose guide information may include information that informs the user that what direction the user has to further move specific body parts in and how to further move the body parts when taking the second action on the basis of the difference vector. As another example, the pose guide information may include information that visualizes the difference vector between the first action and the second action using an indicator such as an arrow. As another example, the pose guide information may include information that evaluates the operation ratios of specific body parts of the user. As another example, the pose guide information may include information showing that the degrees of concordance of specific body parts of the user to other body parts, particularly, symmetric body parts (e.g., the left arm and the right arm) in the first action are different. As another example, the guide pose information may include statistic information showing that the degree of concordance of a second action of the user copying a specific type of first action is low. Further, it is apparent that various items of information that can be obtained by comparing the first action and the second action can be used as pose guide information within the range of the present disclosure by exercise assistance methods that are known in the art or will be newly developed.

The pose guide information can be displayed through the interface 700, and according to a preferred embodiment of the present disclosure, can be displayed with the second video and the second action (S670). The second video, the second action, and the pose guide information may be displayed by the second video display function (730) of the interface 700, the second action display function (740) of the interface 700, and the pose guide display function (750) of the interface 700, respectively.

Display of the second action, similar to the first action, may be performed, for example, through visualization (745), by a procedure including a step of converting object pose information, which is included in the first action, into a graphic element which is a reconstructed shape of an object. An embodiment of the visualization may be applied to visualization (725) for displaying the first action.

The second video display function (730) and the second action display function (740) may be separated from each other in the interface 700, or, depending on embodiments, they may partially or entirely overlap each other. For example, in the modified embodiment of the present disclosure, the second action display function (740) may be displayed to be overlaid on the second video display function (730).

The pose guide display function (750) may be displayed at any position in the interface 700. For example, the pose guide display function (750) may be displayed to be adjacent to or to overlap the second action display function (740). However, in the modified embodiment of the present disclosure, the pose guide display function (750) may be displayed in a splash message type that is temporarily overlaid on the entire interface 700, or may be displayed in various types to a user to improve the detailed implementation method of the pose guide information and the service experience of the user.

In the modified embodiment of the present disclosure, the pose guide display function 750 may be implemented not to occupy the display 310. For example, the pose guide display function 750 may be configured to be included in a voice effect of the interface 700 and displayed through a speaker device of the terminal device.

According to a preferred implement method of the present disclosure, the function of displaying the first video (710), the function of displaying the first action (720), the function of displaying a second video (730), the function of displaying a second action (740), and the function of displaying a pose guide (750) through the interface 700 may be substantially simultaneously combined into one display image and displayed on the display 305. The interval until a user who observes the first video and takes a second action copying the first action is recorded and displayed as a second video (730) after the first video is displayed (710) and the interval that is taken until the first action and the second action are compared may be ignored, according to the performance of an information communication device used for implementing the present disclosure and factors of other implement methods. Further, it is apparent that it is possible to deal with a delay that is generated in the process of calculation or communication using the technologies of implementing applications that are generally known.

### Second Embodiment

Hereafter, a second embodiment of the present disclosure that is derived from the first embodiment by changing an implementation method is described.

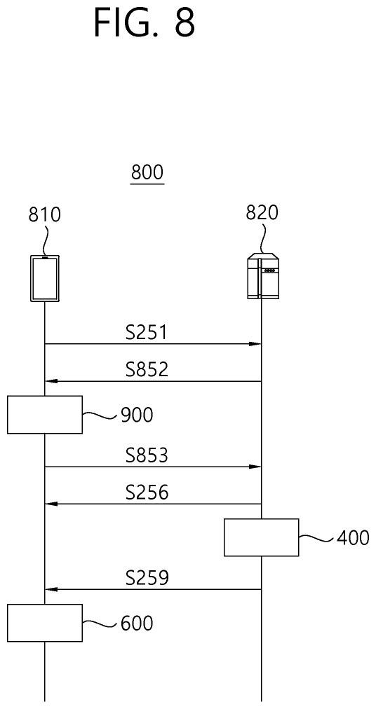

FIG. 8 is an operational conceptual view of a service for providing a user pose guide by the second embodiment of the present disclosure. A service system 800 shown in FIG. 8, for example, is for providing a home training service by providing a pose guide according to the present disclosure and may include a terminal device 810 and a service device 820.

The first embodiment may be applied to describe components having the same reference numerals as those shown in FIG. 2 in the description of FIG. 8.

In the following second embodiment that does not limit the implementation method of the present disclosure, the content provider 230 in the first embodiment may not be separately provided. The server device 820 is a server installed to provide the service and may be configured to include a content storage that stores digital videos that may be used as at least one first video, and a function that supplies the digital video information through a world wide web using a single file, or a streaming packet, or a similar digital data exchange method. Further, the server device 820 may be configured to include the function of the first action extractor of the first embodiment.

When the service is started on the terminal device 810 by the user, the terminal device 810 can connect with the server device 820 that provides the service (S251). In response to the connection (S251), the server device 820 can provide interface information to the terminal device 810 (S852). When the interface information is received (S852), a corresponding interface 900 may be displayed on the terminal device 810.

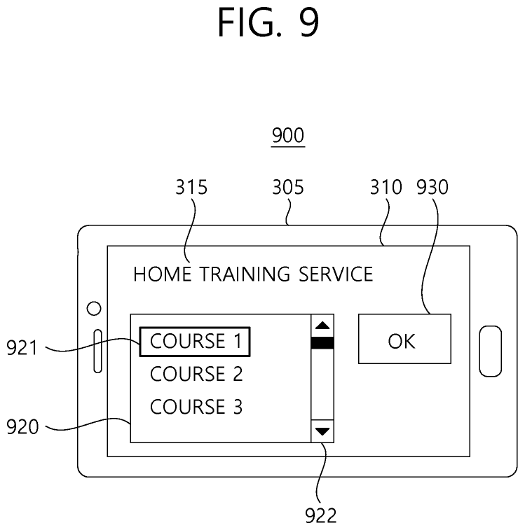

This process is further described hereafter with reference to FIG. 9. FIG. 9 is an exemplary view of an interface that can be displayed on a terminal device on the basis of interface information by the second embodiment of the present disclosure. In the description of the second embodiment that does not limit the implementation method of the present disclosure, the interface 900 may have an objective that designates a first video that the user intends to use for the home training service.

The interface 900 may be displayed through the display 310 of the terminal device 305. The interface 900 may include a function of providing a list of candidate videos that are stored in the server device 820 and are permitted to be used by the user (920), and a function of giving an instruction to transmit video selection information, which is information showing that at least one video of the candidate videos has been selected as the first video, to the server device 820 (930). The interface may further include a display item 315 showing the objective of the interface, for example, a display item showing the name of the service. However, these functions of the interface 900 are examples, and functions of the interface 900 may be added, changed, or removed as long as they keep the technical objectives of the present disclosure.

The list 920 of candidate videos may be provided in a scrollable list or drop-down list type having a scroll function (922) in the interface. The user can search for a candidate video of a first video, which can be used through the server device 820 for the service 800, through the list 920, and can input the video selection information by selecting one of them (921).

The user can make the terminal 220 transmit the video selection information to the server device 820 using the instruction function (930), and accordingly, the server device 820 can provide the first video to the terminal device 810 (S256).

In the second embodiment, the description of the first embodiment and the modification thereof may be applied in the same way to the implementation after the providing of the first video (S256). The embodiment of the service operation 600 described above though FIG. 6 may also be applied in the same way. Further, the embodiment 201 applied from the first embodiment to correspond to a plurality of objects in a first video may also be combined with the second embodiment in the same way.

### Third Embodiment

Hereafter, a third embodiment of the present disclosure that is derived from the first embodiment by changing an implementation method is described.

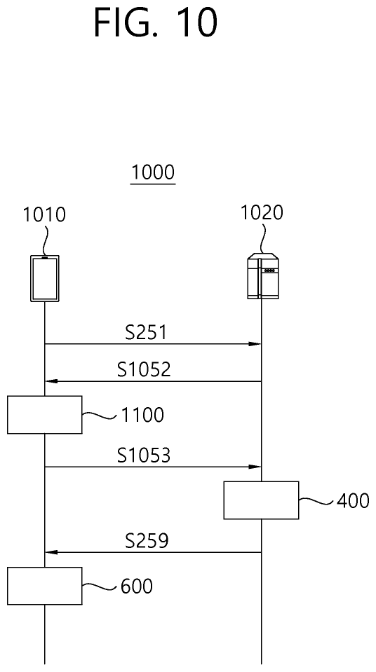

FIG. 10 is an operational conceptual view of a service for providing a user pose guide by the third embodiment of the present disclosure. A service system 1000 shown in FIG. 10, for example, is for providing a home training service by providing a pose guide according to the present disclosure and may include a terminal device 1010 and a service device 1020.

The first embodiment may be applied to describe components having the same reference numerals as those shown in FIG. 2 in the description of FIG. 10.

In the third embodiment that does not limit the implementation method of the present disclosure, the first video can be provided from the terminal device 1010. The server device 1020 is a server installed to provide the service and may be configured to include the function of the first action extractor of the first embodiment.

When the service is started on the terminal device 1010 by the user, the terminal device 1010 can connect with the server device 1020 that provides the service (S251). In response to the connection (S251), the server device 1020 can provide interface information to the terminal device 1010 (S1052). When the interface information is received (S1052), a corresponding interface 1100 may be displayed on the terminal device 1020.

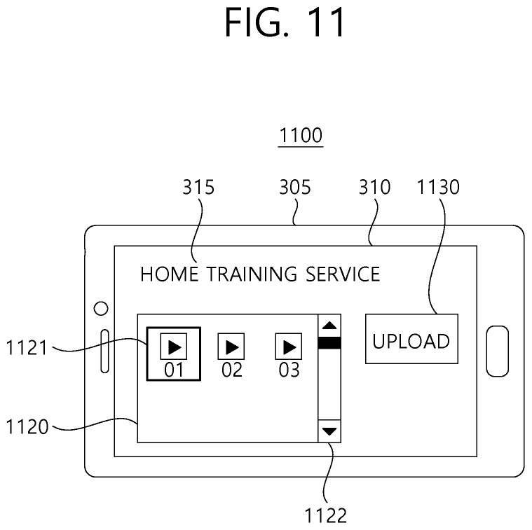

This process is more described hereafter with reference to FIG. 11. FIG. 11 is an exemplary view of an interface that can be displayed on a terminal device on the basis of interface information by the third embodiment of the present disclosure. In the description of the third embodiment that does not limit an implementation method of the present disclosure, the interface 1100 may have an objective that directly provides a first video that the user intends to use for the home training service.

The interface 1100 may be displayed through the display 310 of the terminal device 305. The interface 900 may include a function of providing a list of videos stored in the terminal device 1010 (1120) and a function of giving an instruction to transmit video selection information, which includes at least one item of video information determined to be used as the first video of the above videos, to the server device 1020. The interface may further include a display item 315 showing the objective of the interface, for example, a display item showing the name of the service. However, these functions of the interface 1100 are examples, and functions of the interface 1100 may be added, changed, or removed as long as they keep the technical objectives of the present disclosure.

The user can search for a candidate video of a first video to be used to us the service 1000 through the list 1120, and can select at least one of them (1121). The user can make the terminal 1010 transmit the video selection information to the server device 1120 using the instruction function (1130), and the server device 1020 can receive the first video from the terminal device 1010 through the video selection information (S1053). Accordingly, unlike the embodiments described above, the server device 1020 of the third embodiment does not need the step of providing the first video to the terminal device 1010 and may be configured to extract a first action from the received first video (400).

In the third embodiment, the process described in the first embodiment and the modification thereof may be applied in the same way to the implementation after the extracting of the first video (400). The embodiment of the service operation 600 described above though FIG. 6 may also be applied in the same way. Further, the embodiment 201 applied from the first embodiment to correspond to a plurality of objects in a first video may also be combined with the third embodiment in the same way.

### Fourth Embodiment

Hereafter, a fourth embodiment of the present disclosure that is derived from the first embodiment by changing an implementation method is described. Further, modified embodiments that can be additionally applied or modified from the main embodiments described above by the discretion of appliers who are those skilled in the art when implementing the first embodiment are also described.

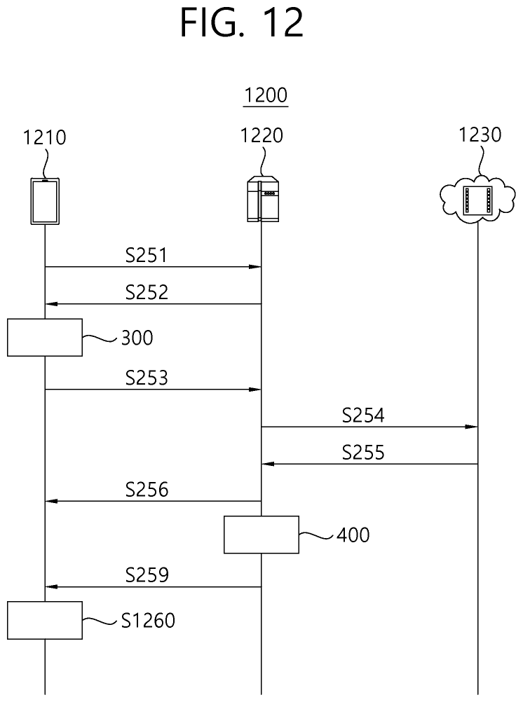

FIG. 12 is an action conceptual view of a service for providing a user pose guide by a fourth embodiment of the present disclosure. A service system 1200 shown in FIG. 12, for example, is for providing a home training service by providing a pose guide according to the present disclosure and may include a terminal device 1210, a service device 1220, and a content provider 1230.

The first embodiment may be applied to describe components having the same reference numerals as those shown in FIG. 2 in the description of FIG. 12.

In the following fourth embodiment that does not limit the implementation method of the present disclosure, a method of implementing the present disclosure that does not need to acquire a second video and compare the second action, which are shown in the first, second, and third embodiments described above, is provided.

In the fourth embodiment, the description of the first embodiment and the modification thereof may be applied in the same way to the implementation method until the first action is extracted (400) and then transmitted from the server device 1220 to the terminal device 1210 (S259).

That is, according to an implementation method of the present disclosure that provides a user pose guide by the fourth embodiment, the terminal device 1210 can connect with the server device 820 that provides the service (S251), and the server device 1220 can provide interface information to the terminal device 1210 (S252) in response to the connection (S251). When the interface information is received (S252), a corresponding interface 300 may be displayed on the terminal device 252.

It is possible to input video selection information through the interface 300, and the video selection information can be transmitted to the server device 11220 (S253) and then can be transmitted to the content provider 1230 (S254). The content provider 1230 can provide the first video to the server device 1230 on the basis of the video selection information (S255), and the terminal device 1210 can obtain a first video in which the first action is recorded from the server device 1230.

The server device 1220 includes a first action extractor and can extract the first action from the first video using the first action extractor. Accordingly, the first action extractor may be configured to extract a first action by extracting at least one video frame from the first video, generating at least one time of object joint information on the basis of the at least one video frame, generating at least one item of object skeleton information on the basis of the at least one video frame, generating at least one item of object pose information by combining the at least item of object joint information and the at least one item of object skeleton information, and continuously combining the at least one item of object pose information.

As the result of extraction, information about the first action can be provided to the terminal device from the server device 1220 (S259). Since the first video and the first action are secured, the terminal device 1210 may be configured to perform a service operation 1260 on the basis of them.

In the description of the fourth embodiment that does not limit an implementation method of the present disclosure, an interface implementing the home training service operation 1260 that helps the user successfully copy the first action shown in the first video may be implemented.

The obtained first video can be displayed to the user. Further, depending on embodiments, the first video may be displayed with the first action. The first video and the first action may be displayed by the first video display function of the interface and the first action display function of the interface, respectively.

Display of the first action may be performed by a procedure including a step of converting object pose information, which is included in the first action, into a graphic pose guide element which is a reconstructed shape of an object. For example, as in an embodiment described above, when object pose information of the present disclosure is composed of object joint information and object skeleton information, the object joint information and the object skeleton information may be visualized and provided as a pose guide to a user.

Further, the embodiment 201 applied from the first embodiment to correspond to a plurality of objects in a first video may be combined with the fourth embodiment in the same way as the first embodiment.

In the fourth embodiment described above, a second video in which a second action of a user observing and copying the first video is not required, and comparing the first action and the second action may be omitted. The pose guide in the fourth embodiment has the type of a first action analyzed from the first video. Accordingly, the pose guide in the fourth embodiment can be usefully provided to a user who wants to obtain a sample of exercise actions or data related to a first action by analyzing the pose information shown in the first video through only the action extractor according to the present disclosure.

### Embodiment of Terminal Device

Hereafter, an embodiment of a terminal device that is used to implement the present disclosure is described.

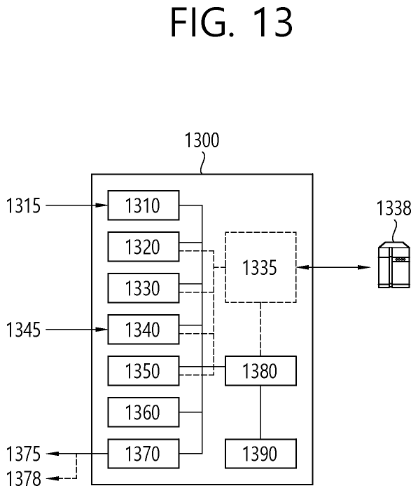

FIG. 13 is a block diagram of a terminal device for providing a user pose guide of the present disclosure. In the following embodiment that does not limit the implementation method of the present disclosure, the terminal device 1300 may include: a first input unit 1310 that receives input of video selection information 1315; a video obtainer 1320 that obtains a first video on the basis of the video selection information; a first processing unit 133 that obtains a first action related to the first video; a second input unit 1340 that obtains a second video in which a second action copying the first action is recorded; a second processing unit 1350 that obtains a second action related to the second video; a third processing unit 1360 that generates pose guide information by comparing the first action and the second action; a display 1370 that displays any one of the first video, the first action, the second video, the second action, and the pose guide information; a processor 1380 that controls operation of each of these components; and a memory 1390 that is connected to the processor.

The display 1370, depending on modifications of the embodiment, may be configured to be connected to the display unit 1375 and to perform visual display. Further, depending on other modifications, the display 1370 may be configured to be connected to a speaker device 1378 and to perform vocal display.

The terminal device 1300 may be a device that implements the terminal devices 210, 810, and 1010 of the first, second, and fourth embodiment of the present disclosure described above. In the terminal devices 210, 810, and 1010 of the first, second, and fourth embodiment, the terminal device 1300 may further include a communication unit 1335 and may be configured to be connected to an external server 1338, that is, corresponding server devices 220, 820, and 1020 in the embodiments and to transmit/receive necessary information.

In some embodiments of the present disclosure, the communication unit 1335 can perform communication for performing the function of at least one of the video obtainer 1320, the first processing unit 1330, the second processing unit 1350, and the third processing unit 1360. When it is required to transmit a first video to the external server 1338, when a first action extractor operates in the external server 1338, when a second action extractor operates in the external server 1338, and when a first action and a second action are compared in the external server 1338, there may be a need for transmitting/receiving information for respective functioning units by means of the communication unit 1335.

Further, when the terminal device 1300 is used as a device that implements the terminal device 1010 of the fourth embodiment of the present disclosure, the second input unit 1340, the second processing unit 1350, and the third processing unit 1360 of the functioning units described above may not be used, and accordingly, they may be omitted within a range not impeding achievement of the objectives of the present disclosure in the fourth embodiment.

### Possibility of Other Modified Implementation

Although the present invention was described above with reference to drawings and the exemplary embodiments, it should be understood that the protective scope of the present disclosure is not limited to the drawings and the exemplary embodiments and the present disclosure may be changed and modified in various ways by those skilled in the art, without departing from the spirit and scope of the present disclosure described in claims. Hereafter, some modifications of the present disclosure are exemplarily described and the possibility of modification of the present disclosure is not limited to the modifications to be described hereafter.

In a modification of the present disclosure, an object identified from at least one of a first video and a second video of the present disclosure may include things other than a human body. Accordingly, it is a fact, which can be easily understood by those skilled in the art, that an object that takes a first action and an object that takes a second action are also not limited to a human body. The structure and general implementation method of the present disclosure described above may be used in the same way without a large change even if the object employed for pose analysis and action comparison is any kind of living or non-living object of which poses can be analyzed, or visual representation of such an object.

As an example that does not limit the application range of the present disclosure, a first video may include a video of a first action that is shown by a virtual human body visualized by computer graphic. As another example, a second video may be obtained by recording a second action of a joint robot copying a first action.

A first video may be supplied in a way a content provider does not have data in a complete type in advance and relays digital video data that are recorded in real time or a delayed real time using a recording device of a terminal device like a second video.

As described in the above third embodiment, when the user provides in person a standard video corresponding to a first video, the first video may be provided in the type of a video file or a plurality of pictures showing continuous frames by the user. The plurality of pictures may be converted into the first video, and if necessary, a conversion process including frame interpolation may be applied.

In various embodiments, a first action extractor may be operated in real time or not in real time, depending on performance instructions provided through a terminal of a user. A server device may be configured, when the first action extractor is operated not in real time, to perform operation of urging operation of the terminal device of the user by transmitting a notification to the terminal device in order to perform a service using a first action when the first action extractor finishes extracting the first action.

A first video and a second video may be compared by different multiple speeds. For example, the user may take a second action by copying the action of the first video played slowly at 0.5× speed or may take a second action by copying the action of the first video played fast at 2× speed.

A first video may be paused, and when a first video is paused, the displaying of the second action may also be paused. Further, comparing a first action and a second action and generating and displaying pose guide information on the basis of the comparison information may also be paused.

A first video may be displayed in loop in which it is repeatedly played from the start even though playing is ended until an instruction is given from a terminal device that a user operates. By the loop, the first video may be repeated a predetermined number of times or infinitely.

When a terminal device receives and uses a first video from a server device, as in the first, second, and fourth embodiments, the first video may be partially or entirely stored as a cache in the terminal device and used to efficiently perform communication with the server device. Similarly, a first action extracted from the first video may be stored as a caches corresponding to the first video in a terminal device or a server device in which the first action extractor is positioned, whereby it is possible to suppress waste of calculation resources due to repeated operation of the first action extractor.

Although the present disclosure was described above with reference to drawings and the exemplary embodiments, as described above, it should be understood that the protective scope of the present disclosure is not limited to the drawings and the exemplary embodiments and the present disclosure may be changed and modified in various ways by those skilled in the art, without departing from the spirit and scope of the present disclosure described in claims.

What is claimed is:

1. A method of providing a user pose guide using a terminal device, the method comprising:
inputting video selection information and obtaining a first video, in which a first action has been recorded, on the basis of the video selection information;
obtaining the first action related to the first video;
displaying the first video;
obtaining a second video in which a second action copying the first action has been recorded;
comparing the first action and the second action; and
displaying pose guide information on the basis of the comparison.

2. The method of claim 1, wherein the obtaining of a first video on the basis of the video selection information includes:
connecting with a server device;
receiving interface information from the server device;
displaying interface information for inputting the video selection information;
inputting and transmitting the video selection information to the server in accordance with the interface information; and
receiving the first video corresponding to the video selection information from the server device.

3. The method of claim 2, wherein the video selection information is information about selecting one of at least one video choice included in the interface information provided from the server device.

4. The method of claim 2, wherein the video selection information includes at least one item of information used for the server device to obtain the first video from a content provider of the first video.

5. The method of claim 4, wherein the video selection information includes at least one of:
communication information identifying the content provider of the first video in a communication network;
identification information used for the content provider to identify the first video;
communication protocol information used to obtain the first video; and
communication authentication information including at least one of an ID, a password, and an authentication key that are required to obtain the first video from the content provider.

6. The method of claim 1, wherein the obtaining of a first video on the basis of the video selection information includes:
displaying interface information for selecting at least one video stored in a storage;
inputting the video selection information in accordance with the interface information; and
obtaining the first video corresponding to the video selection information from the storage.

7. The method of claim 1, further comprising:
extracting the first action from the first video by means of a first action extractor; and
extracting the second action from the second video by means of a second action extractor,
wherein the first action and the second action are information about actions showing pose variation of an object in order of time.

8. The method of claim 7, wherein at least one of the first action extractor and the second action extractor is operated by a pose extraction algorithm, and
the pose extraction algorithm receives a video and outputs an action, and operates, including:
extracting at least one video frame from a video;
generating at least one item of object joint information on the basis of the at least one video frame;
generating at least one item of object skeleton information on the basis of the at least one video frame;
generating at least one item of object pose information by combining the at least one item of object joint information and the at least one item of object skeleton information; and
extracting an action by continuously combining the at least one item of object pose information.

9. The method of claim 8, wherein the pose extraction algorithm operates, further including normalizing the object pose information, and
the normalizing means standardizing the object pose information by applying geometric transformation, which corresponds to at least one of enlarging, reducing, rotating, inversing, and skewing, to at least a portion of the object pose information using at least one vector.

10. The method of claim 8, wherein at least one step of the pose extraction algorithm is operated by an artificial neural network.

11. The method of claim 8, wherein the displaying of the first video includes:
converting object pose information, which is included in the first action, into a pose guide graphic element which is a reconstructed shape of an object; and
displaying the pose guide graphic element with the first video.

12. The method of claim 8, wherein the first action extractor operates in the server device.

13. The method of claim 1, wherein the comparing of the first action and the second action includes obtaining at least one item of pose comparison information by comparing at least one item of object pose information included in the first action and at least one item of object pose information included in the second action using a comparison algorithm,
the at least one item of pose comparison information is information showing at least one of the degree of concordance and a difference vector of the second action to the first action, and
the pose guide information is generated on the basis of the at least one item of pose comparison information.

14. The method of claim 13, wherein the comparison algorithm includes normalizing the object pose information included in the second action by applying geometric transformation, which corresponds to at least one of enlarging, reducing, rotating, inversing, and skewing, to at least a portion of the object pose information included in the second action using at least one vector.

15. The method of claim 1, wherein the displaying of pose guide information includes displaying the pose guide information through a display of the terminal device by visualizing and overlaying the pose guide information on at least one of the first video and the second video.

16. The method of claim 1, wherein the displaying of pose guide information includes making the pose guide information into a voice and displaying the voice through a speaker device of the terminal device.

17. The method of claim 1, wherein a plurality of first actions has been recorded in the first video,
the method further comprises selecting at least one item of action discrimination information including information that discriminates times at which actions appear in the first action and information that discriminates objects taking actions in the first video, and
the obtaining of a first action related to the first video obtains only a first action identified on the basis of the action discrimination information from a plurality of first actions related to the first video.

18. A method of providing a user pose guide using a terminal device, the method comprising:
inputting video selection information and obtaining a first video, in which a first action has been recorded, on the basis of the video selection information;
extracting at least one video frame from the first video;
generating at least one item of object joint information on the basis of the at least one video frame;
generating at least one item of object skeleton information on the basis of the at least one video frame;
generating at least one item of object pose information by combining the at least one item of object joint information and the at least one item of object skeleton information;
extracting a first action by continuously combining the at least one item of object pose information;
converting object pose information, which is included in the first action, into a pose guide graphic element which is a reconstructed shape of an object; and
displaying the pose guide graphic element with the first video.

19. A method of providing a user pose guide using a server device, the method comprising:
receiving video selection information for a first video from a terminal device;
requesting the first video information from a content provider on the basis of the video selection information;
obtaining the first video from the content provider:
obtaining a first action related to the first video by means of a pose extraction algorithm; and
transmitting the first video and the first action to the terminal device.

20. A terminal device providing a user pose guide, the terminal device comprising:
a first input unit configured to receive input of video selection information;
a video obtainer configured to obtain a first video on the basis of the video selection information:
a first processing unit configured to obtain a first action related to the first video;
a second input unit configured to obtain a second video in which a second action copying the first action has been recorded;
a second processing unit configured to obtain a second action related to the second video;
a third processing unit configured to generate pose guide information by comparing the first action and the second action;
a display configured to display at least one of the first video, the first action, the second video, the second action, and the pose guide information;
a processor configured to control operation of the above components; and
a memory connected to the processor.
